(19) United States
(12) Patent Application Publication
(10) Pub. No.: US 2007/0124525 A1
(43) Pub. Date: May 31, 2007

(54) SYSTEM AND METHOD FOR PROCESSING DATA RETRIEVAL/STORAGE

(75) Inventors: Feng-Min Shen, TAIPEI (TW); Jung-Wei Chen, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 11/164,599

(22) Filed: Nov. 30, 2005

(51) Int. Cl. G06F 13/14

(52) U.S. Cl. 710/305

(57) ABSTRACT

Disclosed is a system and method for processing data retrieval/storage, which includes a memory data BUS and a logic converter circuit adopted for switching a non-IDE electrical level into an IDE electrical level, and also for switching a address line to an IDE address line, a data line to an IDE data line, a chip select line to nIDE channel chip select line, a control line to IDE control line, and through the nIDE channel chip select line to process channel locating to a IDE device of a IDE channel. Thus, it is possible that the memory data BUS can process data retrieval/storage to the IDE devices in many IDE channels.

### BACKGROUND OF INVENTION

1. Field of the invention

The present invention generally relates to a system and method for processing data retrieval/storage, and more particularly to a system and method for processing data retrieval/storage to a multi-channel IDE by using a memory data BUS, which has a logic converting circuit for switching a non-IDE electrical level to an IDE electrical level so that the memory data BUS can process data retrieval/storage to the IDE devices in many IDE channel.

2. Description of Related Art

With rapid advancement of electronic technology, the semiconductor industry and the information electronic industry dominated market continues to grow creating remarkable change in our life style. For example, a variety of electronic products are being introduced and used in our daily life. This change is not only indicative of advancement of technology but also demonstrate upgraded life quality and change of life style. Many electronic devices utilize various types of memories to store information such as data and temporary files. Especially, nowadays computers, communication products and consumer electronic devices are commonly used.

Furthermore, many storage devices comprise integrated drive electronics (IDE). IDE is an 8 bit or 16 bit interface to control the storage device and the control chip is included in the peripheral device to reduce the cost as well as simplify the interface card. Therefore, many storage devices use the IDE. However, the processor of the storage device is not being designed to support the IDE and the storage capacity of the storage device can not be expanded. More particularly, the latest electronic devices are being designed to be lighter, thinner, shorter and smaller. Thus, too many BUSES on the circuit board occupy significantly larger space and thereby limit the shrinkage of size of the electronic device. Besides, the extra welding jobs could damage the electronic devices and also increase the manufacturing cost.

Therefore, how to use the memory BUS of the electronic device to read the data of the storage device via IDE and to enable a user to use a plurality of storage devices is an important issue for the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a novel system and a method for processing data retrieval/storage.

According to an aspect of the present invention, a logic converter circuit is adopted for switching a non-IDE electrical level into an IDE electrical level, and also for switching an address line (A0-A2) into an IDE address line (IDE_A0-IDE_A2), a data line (D0-D15) into an IDE data line (IDE_D0-IDE_D15), a chip select line (A3-An) into a nIDE channel chip select line (1 ch IDE_CS0-nch IDE_CS0) and a control line (OE, WE) into an IDE control line (IDE_IOR, IDE_IOW), and through the nIDE channel chip select line (1 ch IDE_CS0-nch IDE_CS0) to process channel locating. Thus, it is possible that the memory data BUS can process data retrieval/storage to the IDE devices in many IDE channels.

According to another aspect of the present invention, the logic converter circuit is adopted reduce interference from occurring due to connection of a plurality of devices.

### BRIEF DESCRIPTION OF THE DRAWING

FIG. 1 is a block diagram of a system for processing data retrieval/storage according to an embodiment of the present invention.

FIG. 2 is a flowchart of a method for processing data retrieval/storage according to an embodiment of the present invention.

FIG. 3 is a block diagram of a system for processing data retrieval/storage according to another embodiment of the present invention.

### DETAIL DESCRIPTION OF THE INVENTION

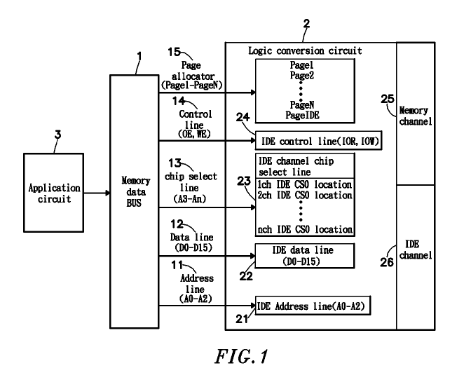

Referring to FIG. 1, a system for processing data retrieval/storage of the present invention comprises a memory data BUS 1 and a logic conversion circuit 2.

The memory data BUS 1 is electrically connected to an application circuit 3 and comprises an address line 11 (A0-A2), a data line (D0-D15), a chip select line 13 (A3-An), a control line (OE, WE) 14 and a page allocator 15 (Page1-PageN).

The logic conversion circuit 2 is electrically connected to the memory data BUS 1 and comprises an IDE address line 21 (IDE_A0-IDE_A2), an IDE data line 22 (IDE_D0-IDE_D15), a nIDE channel chip select line 23 (1 ch IDE_CS0-nch IDE_CS0) and an IDE control line 24 (IDE_IOR, IDE_IOW). The logic converter circuit 2 is also connected to a memory channel 25 and an IDE channel 26.

When the application circuit 3 is ready to read data from a memory module of the memory channel 25, the page allocator 15 (Page1-PageN) of the memory data BUS 1 opens the memory channel 25 first to enable the application circuit 3 to process channel locating and retrieval/storage to the memory module through the address line 11 (A0-A2), the data line 12 (D0-D15) and the chip select line 13 (A3-An), and the application circuit 3 can enable or disable the memory module of the memory channel 25 through the control line 14 (OE, WE). Besides, the application circuit 3 can control the memory module to process reading and writing.

The above memory module may be comprised of a volatile memory, a flash memory, an erasable and an editable ROM, a DRAM, a SDRAM or a SRAM. However, it should be noted that the abovementioned examples are merely used for illustrating the embodiment of the present invention, and therefore should not used to limit the scope of the present invention.

When the application circuit 3 processes data retrieval/storage to an IDE device of the IDE channel 26, the page allocator 15 (Page IDE) of the memory data BUS 1 opens the IDE channel 26 first for the application circuit 3 to transmit a control signal to the logic converter circuit 2 so that the logic converter circuit 2 switches a memory electrical level to an IDE electrical level, the address line 11 (A0-A2) to the IDE address line 21 (IDE_A0-IDE_A2), the data line 12 (D0-D15) to the IDE data line 22 (IDE_D0-IDE_D15), the chip select line 13 (A3-An) to the nIDE channel chip select line 23 (1 ch IDE_CS0-nch IDE_CS0), and the control line 14 (OE, WE) to the IDE control line 24 (IDE_IOR, IDE_IOW). Afterward, the logic conversion circuit 2 processes the channel locating to the IDE device so that the application circuit 3 can process retrieval/storage to the IDE device of the IDE channel 26 through the nIDE channel chip select line 23 (1 ch IDE_CS0-nch IDE_CS0). Thus, the memory data BUS 1 can be connected to the IDE devices in many IDE channels to process data retrieval/storage.

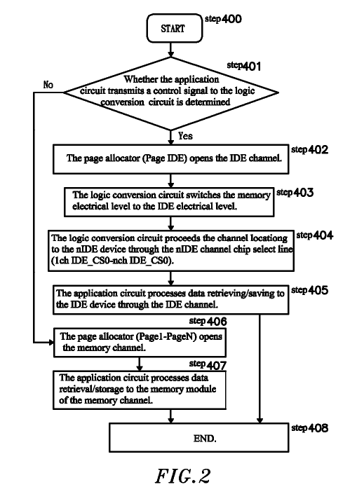

Referring to FIG. 2, the operation procedure of the method for processing data retrieval/storage of the present invention comprises the following steps.

At step 400, the procedure starts.

At step 401, whether the application circuit 3 transmits a control signal to the logic conversion circuit 2 is determined. If yes, the procedure proceeds to step 402, otherwise the procedure proceeds to step 406.

At step 402, the page allocator 15 (Page IDE) opens the IDE channel 26.

At step 403, the logic conversion circuit 2 switches the memory electrical level to the IDE electrical level.

At step 404, the logic conversion circuit 2 precedes channel locating to the nIDE device of the IDE channel 26 through the nIDE channel chip select line 23 (1 ch IDE_CS0-nch IDE_CS0).

At step 405, the application circuit 3 processes data retrieval/storage to the IDE device through the IDE channel 26, and proceeds to step 408.

At step 406, the page allocator 15 (Page1-PageN) opens the memory channel 25.

At step 407, the application circuit 3 processes data retrieval/storage to the memory module of the memory channel 25.

At step 408, the procedure ends.

The above logic circuit 2 may be comprised of a transistor-transistor logic (TTL) or a complementary metal-oxide semiconductor (CMOS) and is adopted for switching the non-IDE electrical level to the IDE electrical level. However, other equivalent element or circuit capable of achieving the same function may also be used to achieve the purpose of the present invention, and therefore any modification in the structure shall be construed to be within the scope of the present invention.

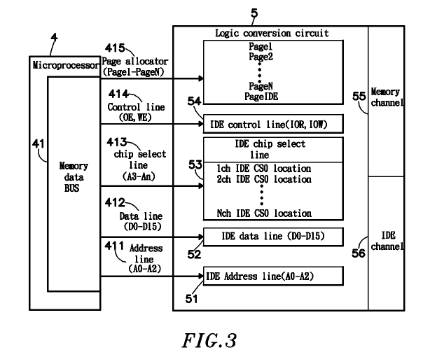

Referring to FIG. 3, a system for processing data retrieval/storage of the present invention comprises a microprocessor 4 and a logic converter circuit 5.

The microprocessor 4 comprises a memory data BUS 41 having an address line 411 (A0-A2), a data line 412 (D0-D15), a chip select line 413 (A3-An), a control line 414 (OE, WE) and a page allocator 415 (Page1-PageN).

The logic converter circuit 5 is electrically connected to the memory data BUS 41 and comprises an IDE address line 51(IDE_A0-IDE_A2), an IDE data line 52 (IDE_D0-IDE_D15), a nIDE channel chip select line 53 (1 ch IDE_CS0-nch IDE_CS0) and an IDE control line 54 (IDE_IOR, IDE_IOW). The logic conversion circuit 5 is also connected to a memory channel 55 and an IDE channel 56.

When the microprocessor 4 reads data from a memory module of the memory channel 55, the page allocator 415 (Page1-PageN) of the memory data BUS 41 opens the memory channel 55 first to enable the microprocessor 4 to process the channel locating and retrieval/storage through the address line 411 (A0-A2), the data line 412 (D0-D15) and the chip select line 413 (A3-An), the microprocessor 4 can enable or disable the memory module of the memory channel 55 through the control line 414 (OE, WE). Besides, the microprocessor 4 can control the memory module to process reading and writing.

The above memory module may be comprised of a volatile memory, a flash memory, an erasable and an editable ROM, a DRAM, a SDRAM or a SRAM. However, it should be noted that the abovementioned examples are merely used for illustrating the embodiment of the present invention, and therefore should not used to limit the scope of the present invention.

When the microprocessor 4 processes data retrieval/storage to an IDE device of the IDE channel 56, the page allocator 415 (Page IDE) of the memory data BUS 41 opens the IDE channel 56 first for the microprocessor 4 to transmit a control signal to the logic converter circuit 5 so that the logic converter circuit 5 switches a memory electrical level to an IDE electrical level, the address line 411 (A0-A2) to the IDE address line 51 (IDE_A0-IDE_A2), the data line 412 (D0-D15) to the IDE data line 52 (IDE_DO-IDE_D15), the chip select line 413 (A3-An) to the nIDE channel chip select line 53 (1 ch IDE_CS0-nch IDE_CS0) and the control line 414 (OE, WE) to the IDE control line 54 (IDE_IOR, IDE_IOW). Afterward, the logic conversion circuit 5 processes the channel locating to the IDE device so that the microprocessor 4 can process retrieval/storage to the IDE device of the IDE channel 56 through the nIDE channel chip select line 53 (1 ch IDE_CS0-nch IDE_CS0). Thus, the memory data BUS 41 can be connected to the IDE devices in many IDE channels to process data retrieval/storage.

The above logic circuit 5 can be the transistor-transistor logic (TTL) or the complementary metal-oxide semiconductor (CMOS) and is only to convert the non-IDE electrical level to the IDE electrical level; other element or circuit of which can achieve the same result can also be used therein. However, other equivalent element or circuit capable of achieving the same function may also be used to achieve the purpose of the present invention, and therefore any modification in the structure shall be construed to be within the scope of the present invention.

Accordingly, the present invention has at least the following advantages.

1. The logic converter circuit is adopted to switch the memory electrical level to the IDE electrical level and processes channel locating to nIDE device of the IDE channel through the nIDE channel chip select line (1 ch IDE_CS0-nch IDE_CS0) so that the memory data BUS can connect to a plurality of IDE devices to process data retrieval/storage and thereby provide more convenience and applicability.

2. Only the memory data BUS is required to process data retrieval/storage to the devices equipped with various interfaces thus effectively reduce the number of the BUS of other interfaces that would substantially allow size reduction of the electronic device and reduce damages from occurring due welding.

3. The memory data BUS is adopted for connecting to a plurality of IDE devices or memory modules, and the logic converter circuit can reduce or eliminates interference between the connected devices.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A system and method for processing data retrieval/storage comprising:
a memory data BUS, electrically connected to an application circuit and comprising an address line, a data line, a chip select line, a control line and a page allocator; and
a logic converter circuit, electrically connected to said memory data BUS and comprising an IDE address line, an IDE data line, an nIDE channel chip select line and an IDE control line;
and further connecting to a IDE channel and a memory channel;
wherein when said page allocator opens said memory channel, said application circuit can process data retrieval/storage to a memory module of said memory channel, and when said page allocator opens said IDE channel, said logic conversion circuit switches said address line to said IDE address line, said data line to said IDE data line, said chip select line to said nIDE channel chip select line and said control line to said IDE control line and processes channel locating to a IDE module of said IDE channel through said nIDE channel chip select line so that said application circuit can process data retrieval/storage to said IDE device of said IDE channel.

2. The system and method for processing data retrieval/storage as claimed in claim 1, wherein said logic conversion circuit comprises a transistor-transistor logic (TTL).

3. The system and method for processing data retrieval/storage as claimed in claim 1, wherein said logic conversion circuit comprises a complementary metal-oxide semiconductor (CMOS).

4. The system and method for processing data retrieval/storage as claimed in claim 1, wherein said memory module comprises a volatile memory, a flash memory, an erasable and editable ROM, a DRAM, a SDRAM or a SRAM.

5. A system and method for processing data retrieval/storage comprising:
a microprocessor, comprising a memory data BUS, and said memory data BUS comprising an address line, a data line, a chip select line, a control line and a page allocator; and
a logic converter circuit, electrically connected to said memory data BUS and comprising an IDE address line, an IDE data line, an nIDE channel chip select line and an IDE control line; and further connecting to a IDE channel and a memory channel;
wherein when said page allocator opens said memory channel, said microprocessor can process data retrieval/storage to a memory module of said memory channel, and when said page allocator opens said IDE channel, said logic conversion circuit switches said address line to said IDE address line, said data line to said IDE data line, said chip select line to said nIDE channel chip select line and said control line to said IDE control line and processes channel locating to a IDE module of said IDE channel through said nIDE channel chip select line so that said microprocessor can process data retrieval/storage to said IDE device of said IDE channel.

6. The system and method for processing data retrieval/storage as claimed in claim 5, wherein said logic conversion circuit comprises a transistor-transistor logic (TTL).

7. The system and method for processing data retrieval/storage as claimed in claim 5, wherein said logic conversion circuit comprises a complementary metal-oxide semiconductor (CMOS).

8. The system and method for processing data retrieval/storage as claimed in claim 5, wherein said memory module comprises a volatile memory, a flash memory, an erasable and editable ROM, a DRAM, a SDRAM or a SRAM.
